(19) United States
(12) Patent Application Publication
(10) Pub. No.: US 2005/0133599 A1
(43) Pub. Date: Jun. 23, 2005

(54) Image capture apparatus

(75) Inventors: Ming-Kuan Qian, Nan-Tung (CN); Ming-Tsung Cheng, Taipei (TW); Kun-Yee Yang, Taipei (TW)

Correspondence Address: SNELL & WILMER;ONE ARIZONA CENTER, 400 EAST VAN BUREN, PHOENIX, AZ, 850040001, US

(73) Assignee: BENQ CORPORATION A Corporation organized under the laws of Taiwan, Taoyuan (TW)

(21) Appl. No.: 11/020,854

(22) Filed: Dec. 22, 2004

(30) Foreign Application Priority Data
Dec. 23, 2003 (TW) 92136513

(51) Int. Cl. G06K 7/10; G06K 7/14

(52) U.S. Cl. 235/454

(57) ABSTRACT

An image capture apparatus is provided. The image capture apparatus includes a window glass, an image sensor under the window glass, a spacer that is between and firmly in contact with the window glass and the image sensor, and an adjustment module connected to the image sensor. The adjustment module adjusts the relative distance between the spacer and the image sensor module to accommodate different objects to be scanned. The present invention also provides a novel approach to adjust the relative distance between the spacer and the image sensor module by utilizing convex portions and corresponding depressions on the spacer and the image sensor module.

### CROSS REFERENCE TO RELATED APPLICATIONS

This Application claims priority to Taiwan Patent Application No. 92136513 entitled “Image Capture Apparatus,” filed on Dec. 23, 2003.

### FIELD OF THE INVENTION

The present invention provides an image capture apparatus that is able to accommodate different sizes of objects to be scanned by adjusting the relative distance between a spacer and an image sensor module.

### BACKGROUND OF THE INVENTION

A variety of optical components of image capture apparatus meet different functional requirements. The contact image sensors (CIS) are commonly used in thinner scanners or ones that require shorter response time. Due to the small depth of field of the CIS component, the CIS component has to be kept as close to the window glass as possible to ensure better scanning quality. Keeping the CIS component firmly in contact with the window glass is key to ensuring image quality.

FIG. 1a shows a side view of a prior art image sensor module. As shown in FIG. 1, spacers 103 are located between and firmly in contact with the window glass 105 and the image sensor module 101 to ensure the scanning quality. The object to be scanned 107 is disposed on the window glass 105 to maintain scanning quality during scanning. As shown in FIG. 1a, the spacers 103 are disposed on two sides of the image sensor module 101 while the window glass 105 is parallel to the image sensor 101. In prior art modules, an elastic device (not illustrated) can be disposed above the image sensor module 101 to provide a force to maintain the spacer 103 firmly in contact with the image sensor module 101 and the window glass 105. Details of such are found in Chinese Issued Patent 143606 or U.S. Pat. No. 6,611,364. It should be noted that the methods of placing elastic devices in the present invention can be but are not limited to those in the foregoing patents.

FIG. 1b shows a side view of the image sensor module of the prior art from another direction. Referring to FIG. 1b, readers would have a clearer understanding about the relative positions of the image sensor module 101, the spacer 103, the window glass and the object to be scanned 107. The side views described thereafter are from the same viewpoint with FIG. 2b.

In prior art, when the object to be scanned 107 is something other than a document, such as a photo negative, it is disposed in a holder. Because of the thickness of the holder, this method degrades the scanning quality in the case of distance-sensitive contact image module. Solving this problem will improve the scanning quality and efficiency.

### SUMMARY OF THE INVENTION

One aspect of the present invention is to provide an image capture apparatus that accommodates objects to be scanned of various sizes by adjusting the relative distance between a spacer and an image sensor module of the image capture apparatus.

The image capture apparatus of the present invention includes a window glass, an image sensor located below the window glass, a spacer disposed between and firmly in contact with the window glass and the image sensor, and an adjustment module connected to the image sensor. The adjustment module adjusts the relative distance between the spacer and the image sensor module to accommodate different objects to be scanned.

The present invention also includes another adjustment method wherein the relative distance between the spacer and the image sensor module is adjusted to accommodate different objects by utilizing the convexes and depressions in the spacer and the image sensor module.

### BRIEF DESCRIPTION OF THE DRAWINGS

FIG. 1a shows a side view of a prior art image sensor module.

FIG. 1b shows a side view of the image sensor module of the prior art from another direction.

FIG. 2a shows a side view of the image capture apparatus of one embodiment of the present invention.

FIG. 2b shows a side view of the image capture apparatus of the embodiment of the present invention illustrated in FIG. 2a.

FIG. 3a shows a side view of the image capture apparatus of another embodiment of the present invention.

FIG. 3b shows a side view of the image capture apparatus illustrated in FIG. 3a.

FIG. 3c shows a schematic diagram of the location of the motor in the embodiment of FIGS. 3a and 3b.

FIG. 4a shows a side view of the image capture apparatus of another embodiment of the present invention.

FIG. 4b shows a side view of the image capture apparatus illustrated in FIG. 4a.

FIG. 5 shows a schematic diagram of how to switch scanning modes in the embodiment of FIGS. 4a and 4b.

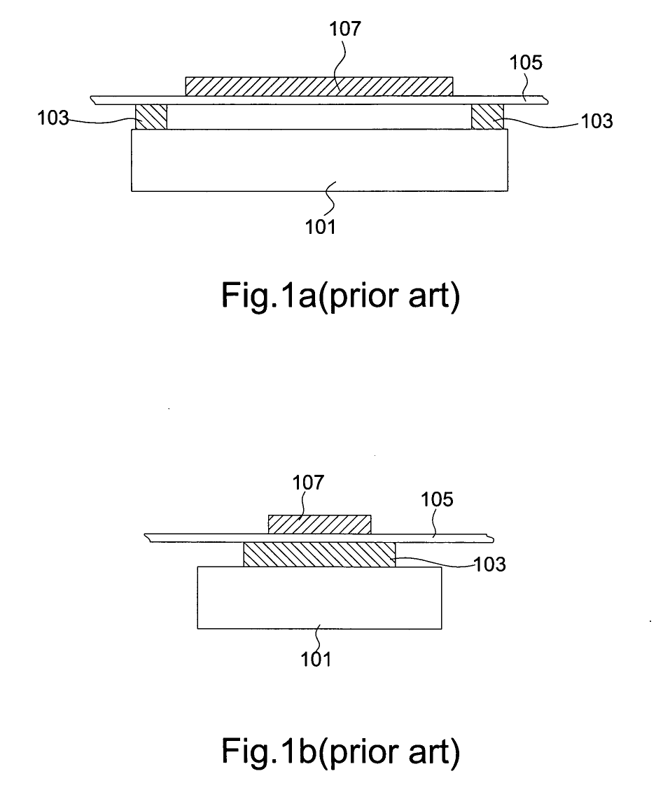

### DETAILED DESCRIPTION OF THE INVENTION

The present invention provides an image capture apparatus, wherein a relative distance between a spacer and an image sensor module of the image capture apparatus can be adjusted to apply to different objects to be scanned.

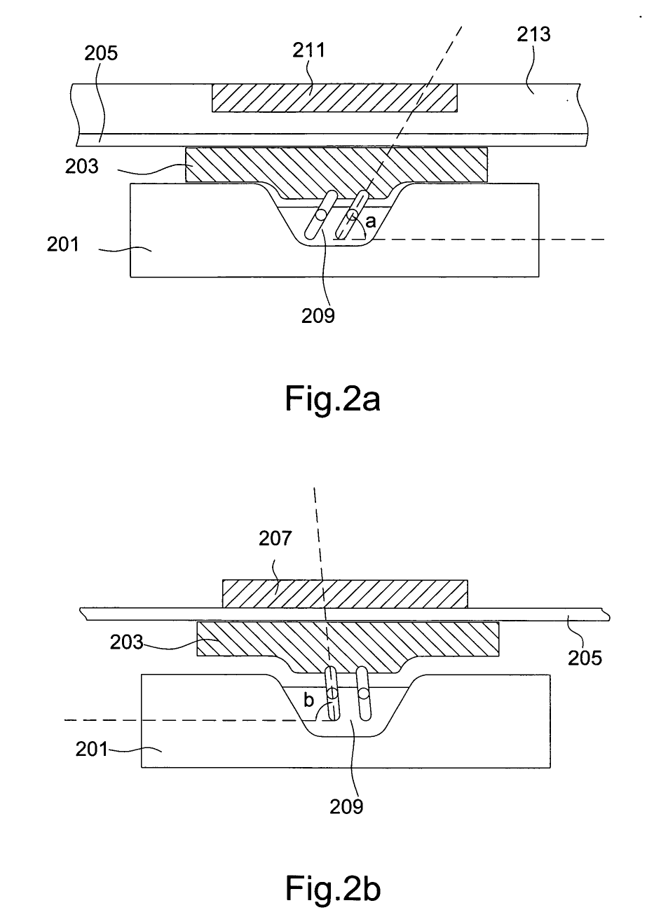

FIG. 2a shows a side view of the image capture apparatus in one embodiment of the present invention. As shown in FIG. 2a, the image capture apparatus of the present invention includes an image sensor 201, a spacer 203, the window glass 205 and the adjustment module 209. The image sensor module 201 includes an image sensor component, for example, a compact image sensor, to capture images. During scanning, keeping the spacer 203 close to the window glass 205 and the image sensor module 201 is essential for ensuring scanning quality. The adjustment module 209 adjusts the relative distance between the image sensor module 201 and the spacer 203. The image sensor module 201 includes an elastic device (not illustrated) providing a force to make the spacer 203 firmly in contact with the image sensor module 201 and the window glass 205.

As shown in FIG. 2a, the image sensor module 201 is in a first scanning state and the spacer 203 is at a first position. The first object to be scanned 211 is put in the holder 213 first, and then the holder 213 is disposed on the window glass 205 for scanning. The first object 211 to be scanned here includes objects that require their own light source, (which can be disposed in the upper cap,) for example, photo negatives or transparencies.

FIG. 2b shows a side view of the image capture apparatus of FIG. 2a wherein the image sensor module 201 is in a second scanning state and the spacer 203 is at a second position. The second object to be scanned 207 is directly disposed on the window glass 205 for scanning. The second object to be scanned 207 here includes objects that can be scanned by using reflection, such as a piece of paper or a photo.

Referring to FIGS. 2a and 2b, as the image sensor module switched between the first and the second scanning states, the adjustment module 209 adjusts the relative distance between the image sensor module 201 and the spacer for different objects. An exemplary adjustment module 209 includes a linkage-rod mechanism. For example a 4-rod linkage mechanism (two rods on each side; an even number of rods is chosen for stability). In other embodiments, the number of rods can be changed or the entire mechanism could be replaced with another mechanism that has a similar function. As shown in FIG. 2a, the image sensor module 201 is in the first scanning state and the rod of the adjustment module 209 is disposed at an angle “a” to the surface plane. The relative distance between the image sensor 201 and the spacer 203 is the first distance. When the user switches the image sensor module to the second scanning state, the transmission device (not illustrated) moves the image sensor module 201 to a specific position (for example, to one side of the image capture apparatus). After that, a rib device (not illustrated) on the housing pushes the rod to make the rod at an angle “b” to the surface plane. As shown in FIG. 2b, the image sensor module 201 is in the second scanning state and the rod of the adjustment module 209 is disposed at an angle “b” to the surface plane. The relative distance between the image sensor 201 and the spacer 203 is the second distance. If the angle “b” is greater than the angle “a,” the second distance is larger than the first distance. The relative distance between the image sensor module 201 and the spacer 203 can be adjusted for different objects by controlling the angle between the rods and the surface plane.

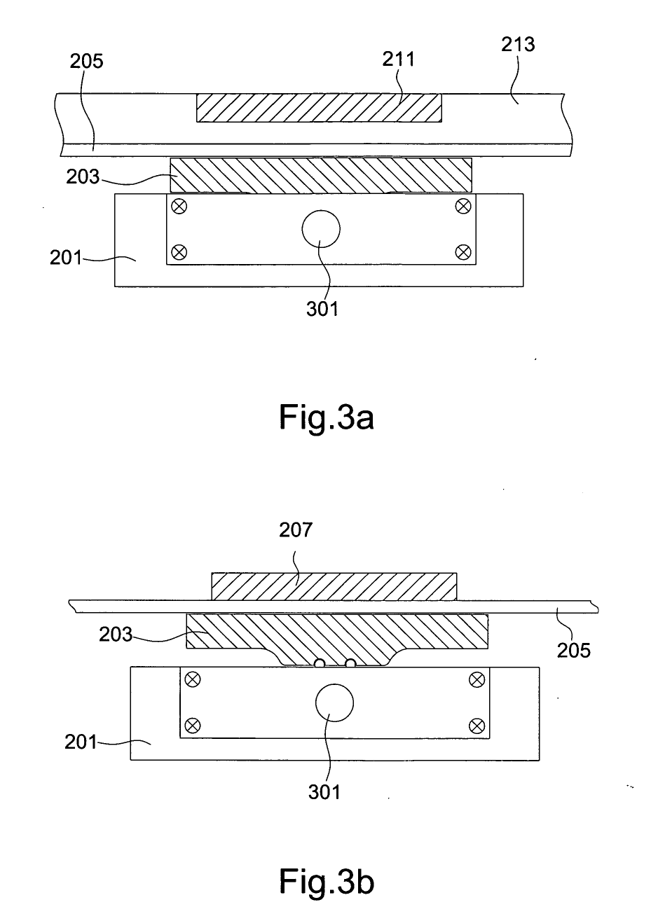

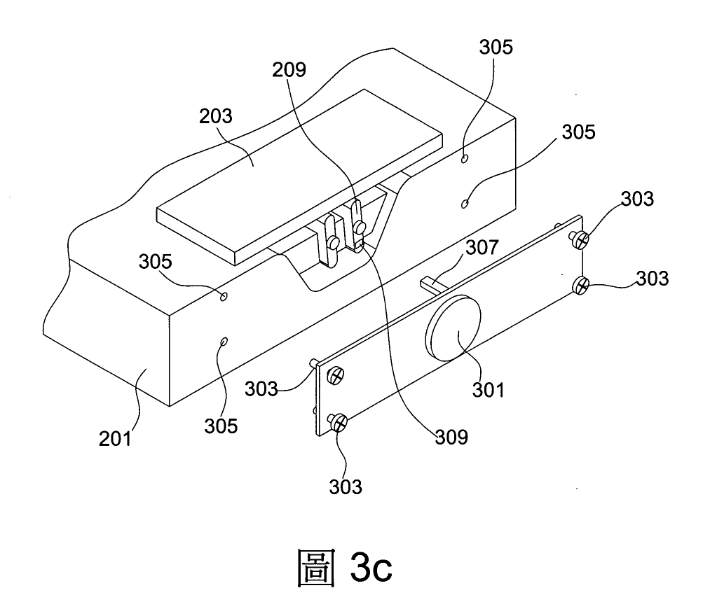

FIG. 3a shows a side view of the image capture apparatus of another embodiment of the present invention. The image sensor module 201 in FIG. 3a is in the first scanning state. FIG. 3b shows a side view of the image capture apparatus illustrated in FIG. 3a, wherein the image sensor module 201 in FIG. 3b is in the second scanning state. In the embodiment in FIGS. 3a and 3b, a motor 301 rotates to adjust the linkage-rod mechanism of the adjustment module 209 (not illustrated in FIGS. 3a and 3b) and thereby adjusts the relative distance between the image sensor module 201 and the spacer 203.

FIG. 3c shows a schematic diagram of the location of the motor in the embodiment of FIGS. 3a and 3b. As shown in FIG. 3c, the motor 301 is connected to a pole 307 and the linkage rod of the adjustment module 209 includes a slot 309. When the motor 301 is connected to the adjustment module 209, the pole 307 is placed in the slot 309 exactly. Having the pole 307 contacting the sidewalls of the slot 309 allows the motor 301 to directly adjust the linkage rod. Alternatively, the motor 301 could be fixed on the image sensor module by appropriate arrangement of screws 303 and screw holes 305.

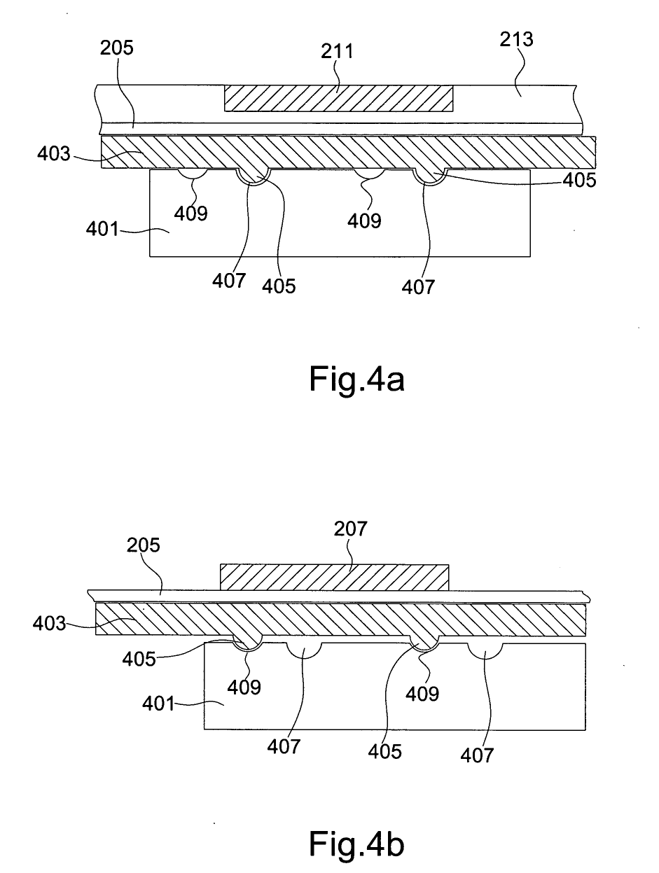

FIGS. 4a and 4b show side views of the image capture apparatus of yet another embodiment of the present invention. In this embodiment, another method of adjusting the relative distance between the image sensor module 401 and the spacer 403 is provided. As shown in FIG. 4a, the image sensor module 401 is in the first scanning state with the first distance between the spacer 403 and the image sensor module 401. The image sensor module 401 includes two first depressions 407 and two second depressions 409, and the depth of the first depressions 407 is greater than the depth of the second depressions 409. The spacer 403 includes two convex portions 405. The convex portions 405 can slide into the first depressions 407 and the second depressions 409 respectively to adjust the relative distance between the image sensor module 401 and the spacer 403.

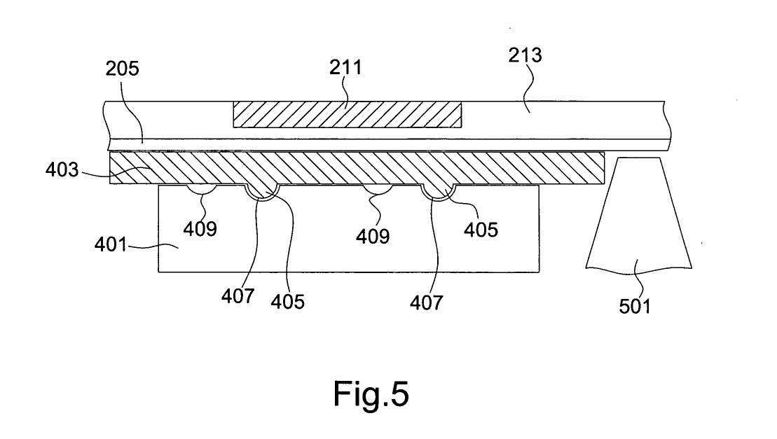

FIG. 5 shows a schematic diagram of how to switch scanning modes in the embodiment of FIGS. 4a and 4b. When the image sensor module 401 is switched from the first scanning state (FIG. 4a) to the second scanning state (FIG. 4b), the transmission device (not illustrated) moves the image sensor module 401 to a specific position (for example, to one side of the image capture apparatus). Then, as shown in FIG. 5, the rib device on the housing pushes the spacer 403 to make the convex portions 405 slide out of the first depressions 407 and slide into the second depressions 409. Then the relative distance between the image sensor module 401 and the spacer 403 is the second distance, and the second object to be scanned 207 can be disposed on the window glass 205 directly (as shown in FIG. 4b). By the same approach, when the image sensor module 401 is switched from the second scanning state (FIG. 4b) to the first scanning state (FIG. 4a), the transmission device (not illustrated) moves the image sensor module 401 to another specific position (for example, another side of the image capture apparatus). The rib device on another side of the housing pushes the spacer 403 to make the convex portions 405 slide out of the first depressions 409 and slide into the second depressions 407 (not illustrated).

It should be noted that, numbers and positions of the convex portions 405, the first depressions 407 and the second depressions 409 are not fixed and can be changed by users. In other embodiments, the convex portion 405 can be disposed on the image sensor module 401 as the first depressions 407 and the second depressions 409 are disposed in the bottom of the spacer 403 to perform the same function.

While the invention has been described in connection with what is presently considered to be the most practical and preferred embodiments, it is to be understood that the invention is not to be limited to the discovered embodiments. The invention is intended to cover various modifications and equivalent arrangement included within the spirit and scope of the appended claims.

1. An image capture apparatus comprising:
a window glass;
an image sensor module located below the windows glass; and
a spacer disposed between the window glass and the image sensor, the spacer contacting closely with the window glass and relatively movably disposed on the image sensor module with a relative distance between the spacer and the image sensor module; and
wherein, the relative distance is a first distance as the spacer moves to a first position, and the relative distance is a second distance larger than the first distance as the spacer moves to a second position.

2. The image capture apparatus according to claim 1, wherein the image sensor module includes an elastic device, and the elastic device provides a force to make the image sensor module contact closely with the spacer.

3. The image capture apparatus according to claim 2, wherein the force makes the window glass contact closely with the spacer.

4. The image capture apparatus according to claim 1, wherein the window glass allows disposition of a first object to be scanned as the image sensor module is in a first scanning state.

5. The image capture apparatus according to claim 4, wherein the window glass allows disposition of a second object put in a holder to be scanned as the image sensor module is in a second scanning state.

6. The image capture apparatus according to claim 1, further comprising an adjustment module connected to the image sensor module for adjusting the relative distance between the spacer and the image sensor module, the adjustment module including a connecting rod.

7. The image capture apparatus according to claim 6, wherein the adjustment module further includes a motor to rotate the connecting rod.

8. The image capture apparatus according to claim 1, wherein the image sensor module includes a support device and a contact image sensor supported by the support device.

9. The image capture apparatus according to claim 1, wherein the image sensor module includes a depression and the spacer includes a convex portion, and the convex portion slides into the depression to make the relative distance as being the first distance as the image sensor module is in a first scanning state, and the convex portion slides out of the depression to make the relative distance as being the second distance as the image sensor module is in a second scanning state.

10. The image capture apparatus according to claim 1, wherein the image sensor module includes a convex portion and the spacer includes a depression, and the convex portion slides into the depression to make the relative distance as being the first distance as the image sensor module is in a first scanning state, and the convex portion slides out of the depression to make the relative distance as being the second distance as the image sensor module is in a second scanning state.

11. An image capture apparatus comprising:
a window glass;
a spacer disposed between the window glass and the image sensor, the spacer contacting closely with the window glass; and
an image sensor module located below the spacer, the image sensor module including an elastic device, the elastic device providing a force to make the image sensor module and the window glass contact closely with the spacer;
wherein, the spacer is relatively movably disposed on the image sensor module with a relative distance between the spacer and the image sensor module, and the relative distance is a first distance as the spacer moves to a first position, and the relative distance is a second distance larger than the first distance as the spacer moves to a second position.

12. The image capture apparatus according to claim 11, wherein the window glass allows disposition of a first object to be scanned as the image sensor module is in a first scanning state.

13. The image capture apparatus according to claim 12, wherein the window glass allows disposition of a second object put in a holder to be scanned as the image sensor module is in a second scanning state.

14. The image capture apparatus according to claim 11, further comprising an adjustment module connected to the image sensor module for adjusting the relative distance between the spacer and the image sensor module, the adjustment module including a connecting rod.

15. The image capture apparatus according to claim 14, wherein the adjustment module further includes a motor to rotate the connecting rod.

16. The image capture apparatus according to claim 11, wherein the image sensor module includes a support device and a contact image sensor supported by the support device.

17. The image capture apparatus according to claim 11, wherein the image sensor module includes a depression and the spacer includes a convex portion, and the convex portion slides into the depression to make the relative distance as being the first distance as the image sensor module is in a first scanning state, and the convex portion slides out of the depression to make the relative distance as being the second distance as the image sensor module is in a second scanning state.

18. The image capture apparatus according to claim 11, wherein the image sensor module includes a convex portion and the spacer includes a depression, and the convex portion slides into the depression to make the relative distance as being the first distance as the image sensor module is in a first scanning state, and the convex portion slides out of the depression to make the relative distance as being the second distance as the image sensor module is in a second scanning state.

19. An image capture apparatus comprising:
a window glass;
an image sensor module located below the windows glass, the image sensor module including a depression; and
a spacer disposed between the window glass and the image sensor with a relative distance between the spacer and the image sensor module, the spacer including a convex portion;
wherein, the convex portion slides into the depression to make the relative distance as being the first distance as the image sensor module is in a first scanning state, and the convex portion slides out of the depression to make the relative distance as being the second distance as the image sensor module is in a second scanning state.

20. The image capture apparatus according to claim 19, wherein the window glass allows disposition of a first object to be scanned as the image sensor module is in the first scanning state, and the window glass allows disposition of a second object put in a holder to be scanned as the image sensor module is in the second scanning state.
